(19) United States
(12) Patent Application Publication
(10) Pub. No.: US 2018/0272520 A1
(43) Pub. Date: Sep. 27, 2018

(54) A Receptacle for Flexible Elongate Members

(71) Applicant: SHANE BRANIFF, BELFAST (GB)

(72) Inventor: SHANE BRANIFF, BELFAST (GB)

(21) Appl. No.: 15/555,955

(22) PCT Filed: Mar. 7, 2016
(86) PCT No.: PCT/EP16/54832

§ 371 Date: Sep. 5, 2017

(30) Foreign Application Priority Data
Mar. 5, 2015 (GB) 1503730.2

(51) Int. Cl. B25H 3/04; B65D 85/08; B65D 43/02; B65D 25/38

(52) U.S. Cl. CPC B25H 3/04; B65D 85/08; B65D 2543/00092; B65D 25/38; B65D 43/0225

(57) ABSTRACT

A container for the storage and transport of flexible elongate members namely cable-ties. The container having an aperture for removal of the flexible elongate members. The portion of the container defining the aperture having means for maintaining at least part of a perimeter of the aperture in a non-planar orientation.

The present invention relates to a receptacle for elongate members and in particular to a receptacle for cable-ties.

Flexible elongate members such as cable-ties or the like have a multitude of practical applications. However storage of such elongate members is often difficult; especially during transport from one installation site to another. Often the cable-ties are pulled from their original packaging and thrown loosely into a tool box where they scatter among the tools and can be difficult to recover. Other conventional storage devices for cable-ties or the like tend to be open ended containers whereby the cable-ties protrude from the structure and are prone to falling out of the container. Further a number of conventional storage devices for cable-ties or the like are not portable; instead being fixed to a workbench or the like.

In addition many users of cable-ties may opt to utilise the original packaging as a make-shift holder for storage. This method is also inefficient as the packaging is not typically designed for the repeated removal and insertion of the ties. As a result the packaging typically becomes deformed and damaged, thus allowing the cable-ties to fall out of the original packaging. The original packaging is usually a flexible plastic bag formed into a tube by the volume of cable-ties and so when a person tries to pinch the cable-ties out of an opening generally made by tearing the bag, grasping a cable-ties is difficult because of the fact that the flexible bag and the cable-ties are in close proximity. This means the operator is grasping at the cable-ties through a tear. Once opened cable-ties regularly fall out through this tear both during use and while in storage.

Another problem with the flexible plastic bag packaging is that the cable-ties generally spread out in a planar fashion as their quantity reduces meaning there is no space between the opening and the cable-ties. In other words the cable-ties are proximal to the opening almost co-planar. This means that a person's grip between their thumb and index finger has limited depth to get a grip of the cable-tie and it can leave a person having to take several grasps at the cable-tie before successfully removing a cable-tie. This is because the sheet of material adjacent the opening and the cable-ties pressed up against or proximal to the opening are almost co-planar leaving no depth for the grasping finger and thumb. This is a frustrating experience for the user who may be using cable-ties regularly as part of their ongoing work.

It is an object of the present invention to obviate the abovementioned problems by providing a receptacle for flexible elongate members wherein the elongate members are contained safely within the receptacle for storage and transport yet easily loadable into, accessible, and removable from the receptacle when required by the user.

Accordingly, the present invention provides a container for flexible elongate members, the container having an aperture for at least removal of the flexible elongate members, at least the portion of the container defining the aperture having means for maintaining at least part of a perimeter of the aperture in a non-planar orientation.

Advantageously, the non-planar orientation of at least part of the perimeter of the aperture means that an operator can always place their thumb and index finger in alignment or partially aligned with the flexible elongate member so that upon closing their thumb and index finger they will be able to apply a clamping force onto at least part of opposing sides of the body of an flexible elongate member proximal to the aperture.

Ideally, the non-planar orientation of all or part of the perimeter creates a three dimensional space around the flexible elongate members.

Preferably, the portion of the container defining the aperture having means for maintaining at least part of the perimeter of the aperture in a convex or concave orientation.

Advantageously, the concave or convex orientation of the perimeter creates a three dimensional space around the flexible elongate members.

Ideally, the portion of the container defining the aperture having means for maintaining at least one part of the perimeter of the aperture at an inclined angle relative to at least one other adjacent part of the perimeter of the aperture.

Ideally, the aperture being adapted to prevent the flexible elongate members coming out of the container without operator intervention.

Preferably, the aperture being adapted to receive a thumb and an index finger in an open position and in a closed grasping position.

Ideally, the aperture being adapted to allow a person to insert their thumb and index finger in an open position into the body of the container.

Advantageously, this allows an operator to apply the same grasping action to flexible elongate members at the back of the container relative to the front position of the aperture.

Ideally, all or part of the perimeter of the aperture is rigid.

Preferably, all or part of the portion of the container defining the aperture is rigid.

Ideally, the container is rigid.

Preferably, the container is an elongate container.

Ideally, the aperture is located away from the ends of the container.

Preferably, the aperture is located towards or about the middle of the container relative to at least two opposite ends.

Ideally, the container has a tubular body.

Preferably, the tubular body is a cylindrical body.

Alternatively, the tubular body has a polygonal shaped cross-section such as a rectangular or pentagonal or hexagonal or heptagonal or octagonal cross-section etc.

Ideally, the container is comprised of a single moulded unit.

Preferably, the container is pre-moulded to shape using injection moulding.

Alternatively, the container comprises modular tubular bodies.

Advantageously, this allows different lengths of containers to be formed by adding tubular bodies to an existing container to accommodate various lengths of flexible elongate members.

Ideally, the tubular body has at least one openable end for receiving the flexible elongate members.

Advantageously, a container for flexible elongate members which comprises at least an end that is openable, provides a user with ease of access to the container to quickly and easily refill the receptacle with additional elongate members.

Preferably, the at least one openable end for receiving the flexible elongate members comprises a separable or rotatably coupleable detachable member, the detachable member being detachable from or moveable relative to the tubular body of the container.

Ideally, the detachable member comprises a closed end and an open end for positively engaging the open end of the tubular body of the container.

Ideally, the detachable member is deformable.

In one embodiment, the internal profile of the detachable member having an interference means extending along a portion of the detachable member for positively engaging the open end of the tubular body of the container.

Preferably, the detachable member inner profile is formed to create an interference fit with the external profile of the tubular body of the container.

Advantageously, this detachable member provides the operator with the lid like structure that is easily pressed onto and pulled off from the tubular body of the container to enable the container to be quickly and easily refilled with flexible elongate members.

Alternatively, a portion of the inner profile of the detachable member and a portion of the external profile of the tubular body of the container comprise correspondingly located threading means.

Advantageously, this embodiment provides the detachable member with a screw-like function to rotate onto and off from the tubular body of the container.

Further alternatively, the detachable member is mechanically coupled to the tubular body of the container via hinge means.

Preferably, the hinge means mechanically coupling the detachable member to the tubular body of the container is located proximal to the at least one openable end of the tubular body.

Ideally, the hinge means enables the detachable member to be rotatable around a fixed point.

Preferably, the hinge means is a hinged joint.

Ideally, the detachable member further comprises a fastening means, to fasten the detachable member in position upon the tubular body of the container.

Preferably, the fastening means is a mechanical fastening means

Most preferably the fastening means is a latch.

Preferably, the tubular body is mountable upon a wall, structural frames, tool boxes, workbenches, vans or the like.

Alternatively, the tubular body is mountable upon a portion of the operator himself such as but not limited to the operator's leg.

Ideally, the tubular body comprises fixed mounting means and/or removably detachable mounting means to mount the tubular body.

By fixed and removable mounting means we mean that the mounting means is permanently fixed to the tubular body of the container whereas a removably detachable mounting means can be disengaged from the container when required.

Ideally, the mounting means is located at the upper half of the tubular body proximal to the aperture.

Preferably, the mounting means is located such that when the container is in use or mounted the flexible elongate members can be removed from the container through the aperture.

Preferably, the mounting means is a clamp or hook or fixing lug or similar mechanical fixings.

Ideally, the tubular body comprises at least one pair of correspondingly located protrusions protruding a short distance from the external surface of the tubular body.

Preferably, the at least one pair of correspondingly located protrusions are locatable within the lower half of the tubular body proximal to the lower end of the container.

Ideally, the at least one pair of correspondingly located protrusions are locatable within the upper half of the tubular body proximal to the upper end of the container.

Most ideally, the tubular body comprises two pairs of correspondingly located protrusions, one pair locatable within the lower half of the tubular body proximal to the lower end of the container, the other pair locatable in the upper half of the tubular body proximal to the upper end of the container.

Preferably, the at least one pair of correspondingly located protrusions protruding a short distance from the external surface of the tubular body are locatable in a position whereby when the container is in use or mounted the flexible elongate members can be removed from the container through the aperture.

Ideally, the least one pair of correspondingly located protrusions comprise apertures to enable removably detachable mounting means to pass through the protrusions to enable mounting of the container.

Preferably, the removably detachable mounting means is an flexible elongate member, an elastic member, Velcro® strip, cord or the like.

Advantageously, a tubular body having at least one pair of correspondingly located protrusions comprising means to enable a removably detachable mounting means, such as flexible elongate members, enables an operator to either permanently or temporarily fix the container to an external support. This is regardless of the type of external support used i.e. work benches, structural piping, vehicles or the operator himself.

Alternatively, the least one pair of correspondingly located protrusions comprise apertures to enable the container to be mechanically mounted by screws or nails or the like.

Most ideally, the aperture is geometrically designed to enable both mechanical mounting means such as screws or the like and/or a removably detachable mounting means such as an flexible elongate member to mount the container depending on the requirements of the user.

Preferably, the hybrid aperture is geometrically designed with a cross like/cruciform configuration to enable both types of mounting means.

Ideally, the cylindrical tubular body has an auxiliary locating and securing means.

Preferably, the auxiliary locating and securing means is locatable in a position whereby when the container is in use or mounted the flexible elongate members can be removed from the container through the aperture.

Preferably, a portion of the tubular body wall protrudes a short distance into the tubular body to create an auxiliary locating and securing means.

Ideally, the auxiliary locating and securing means is angled.

Preferably, the auxiliary locating and securing means is wedge shaped.

Ideally, the wedge is angled at or about 90°.

Preferably, the auxiliary locating and securing means extends a substantial length of the longitudinal length of the tubular body of the container.

Ideally, the auxiliary locating and securing means extends the entire longitudinal length of the tubular body of the container

Advantageously, the auxiliary locating and securing means enables an operator to further securely mount the tubular body to the corners of any work-bench, vehicle, wall or the like. The 90° or similar angle of the securing feature enables the corner of the external structure to nest with the inherent tubular structure of the container.

Preferably, the aperture extends longitudinally along a part of the length of the container.

Ideally, the aperture extends longitudinally along a part of the length of the tubular body of the container.

Preferably, the aperture being adapted to extend over less than 50% of the longitudinal length of the container.

Preferably, the aperture being adapted to extend over less than 40% of the longitudinal length of the container.

Ideally, the aperture being adapted to extend over less than 30% of the longitudinal length of the container.

Preferably, the aperture being adapted to extend over less than 20% of the longitudinal length of the container.

Ideally, the aperture being adapted to extend over less than 10% of the longitudinal length of the container.

Ideally, the aperture extends circumferentially around at least part of the container.

Preferably, the aperture extends circumferentially around at least part of the tubular body of the container.

Ideally, the aperture extends circumferentially around up to 50% of the tubular body of the container.

Preferably, the aperture extends circumferentially around up to 40% of the tubular body of the container.

Ideally, the aperture extends circumferentially around up to 30% of the tubular body of the container.

Preferably, the aperture extends circumferentially around up to 20% of the tubular body of the container.

Ideally, the aperture extends circumferentially around up to 10% of the tubular body of the container.

Advantageously, the perimeter of the aperture extending circumferentially around at least part of the tubular body of the container creates a three dimensional non-planar cavity cutting a jaw shaped cavity through the tubular wall of the container. This three dimensional non-planar opening through the tubular wall provides the space for an operator to place their thumb and finger on opposing sides of and in alignment with all or part of the flexible elongate member.

Preferably, the aperture is a polygonal shaped aperture.

Ideally, the aperture is a rectangular shaped aperture.

Preferably, the aperture is circular.

Most preferably, the aperture is an elliptical shaped aperture.

Preferably, a range of longitudinal lengths and widths of the container for flexible elongate members are provided.

Preferably, the length of the container for flexible elongate members is in the range of 50 mm to 800 mm.

Ideally, the overall longitudinal length of the container for flexible elongate members is in the range of 70 mm and 400 mm.

Ideally, the flexible elongate members are cable-ties.

Preferably, the container is formed of a plastic composite.

Ideally, the container is formed of a thermoplastic composite.

Preferably, the container is formed of polyurethane.

Ideally, the container is formed of polyethylene terephthalate.

Ideally, the container is formed of polyvinyl chloride (PVC)

Preferably, the container is formed of substrate comprising a bibulous matrix such as cardboard.

Ideally, the container is formed of a metallic material.

Preferably, the container is formed of metal alloy.

Accordingly, the present invention provides a first embodiment of a holding means for a container for the storage of flexible elongate members comprising a holding means being length adjustable between a container inserting extended position and a container mounted retracted position, the holding means having a biasing means normally biasing the holding means into the container mounted retracted position.

Preferably, the holding means for a container for the storage of flexible elongate members comprises a two part structural frame and a biasing means for operable engagement with the two part structural frame to secure the container to the structural frame of the holding means.

Ideally, the structural frame of the holding means for the container comprises two frame members.

Preferably, the structural frame of the holding means comprises an upper frame member and a lower frame member operably coupled by the biasing means.

Ideally, the frame members are rigid frame members.

Preferably, the frame members are a lower frame member and/or an upper frame member being displaceable relative to the other.

Ideally, the lower frame member and/or upper frame member is displaceable relative to the other under control of the biasing means as a result of the application of force by the operator.

Ideally, the biasing means is designed for applying a compressive force onto the container for the engagement of the container within the holding means.

Ideally, the rigid frame members are capable of withstanding the compressive forces applied by the biasing means.

Preferably the lower frame member and/or upper frame member comprises a base member for supporting the container within the holding means.

Ideally, the base member protrudes orthogonally relative to the frame members.

Preferably, the base member comprises one or more stabilising components for positively engaging the outer profile of the container.

Preferably, one or more of the stabilising components are deformable.

Ideally, the biasing means is a spring.

Preferably, the holding means is mountable upon a wall, tool box, workbench, van or the like.

Ideally, the holding means comprises mounting means to mount the holding means.

Preferably, the mounting means is connectable to one or both frame members.

Preferably, the holding means is formed of a plastic composite.

Ideally, the holding means is formed of a thermoplastic composite.

Ideally, the holding means is formed of a metallic material.

Preferably, the holding means is formed of metal alloy.

Accordingly, the present invention provides a rack for a plurality of containers for the storage of flexible elongate members, the rack comprising releasable engaging means for releasably securing a plurality of containers for the storage of flexible elongate members to the rack, the container having an aperture for at least removal of the flexible elongate members, at least the portion of the container defining the aperture having means for maintaining at least part of the perimeter of the aperture in a non-planar orientation.

Ideally, the releasable engaging means comprises biasing means for applying a compressive force onto the container to retain the container on the rack.

Advantageously the biasing means securely maintains the container in connection to the rack.

Ideally, the rack comprises a plurality of releasable engaging means to connect a plurality of containers for the storage of flexible elongate members.

Preferably, the releasable engaging means comprises a pair of spaced apart holders for engaging the container at or about both ends.

Ideally, the pairs of holders can be spaced apart on the rack by different distances.

Advantageously, the rack comprising a plurality of releasable engaging means spaced apart at different distances enables an operator to utilise a variety of different lengths of containers to accommodate different thickness and lengths of cable-ties.

Preferably, at least one of the holders has urging means.

Advantageously, the urging means allow at least one holder to move towards and away from the rack and the container allowing an operator to insert the container.

Preferably, the releasable engaging means is a quick release connecting means.

Ideally, the quick release connecting means comprises at least one holder to engage with the container.

Ideally, the holder has an extended position and a retracted position.

Preferably, in normal orientation the holder is in its extended position.

Advantageously, a quick release connecting means comprising at least one holder and urging means enables an operator with a quick and simple method of container exchange should varying lengths and thicknesses of cable-ties be required.

Preferably, the urging means is connected to the rack.

Ideally, the application of force by an operator pressing the container onto the quick release connecting means compresses the urging means towards a portion of the rack.

Preferably, the urging means biases the holder back into the extended position.

Advantageously, the tensile forces of the urging means placed upon the container clamps the container in position on the rack. This clamp like mechanism maintains a secure connection between the container and the rack.

Ideally, the urging means is a spring.

Preferably, the rack comprises an upper and lower rack member and a connecting spine.

Ideally, at least one of the rack members has a releasable engaging means.

Preferably, where the lower rack member houses the releasable engaging means the container is forced towards an abutment portion of the rack located upon the upper rack member and vice versa.

Ideally, the upper and lower rack members are connectable along at least one lateral edge by the connecting spine.

Ideally, the upper and lower rack members protrude orthogonally from the connecting spine.

Preferably, the releasable engaging means is located upon the internal surfaces of the upper and lower rack members.

Preferably, the rack members are rigid rack members.

Ideally, the rigid rack members are capable of withstanding the compressive and tensile forces applied by the quick release connecting means.

Preferably, the rack is mountable upon a wall, tool box, workbench, van or the like.

Ideally, the rack comprises mounting means to mount the rack.

Preferably, the mounting means is a clamp or hook or similar mechanical fixings.

The invention will now be described with reference to the accompanying drawings which shows by way of example embodiments of a container and rack in accordance with the invention.

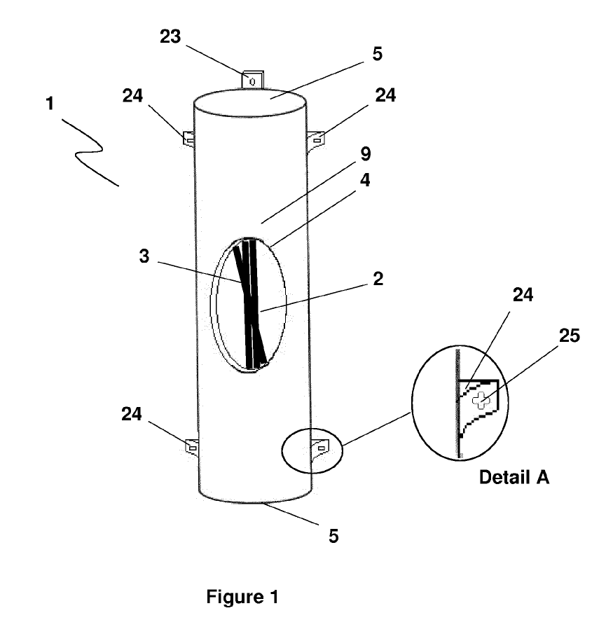

FIG. 1 is a perspective view of the container for flexible elongate members.

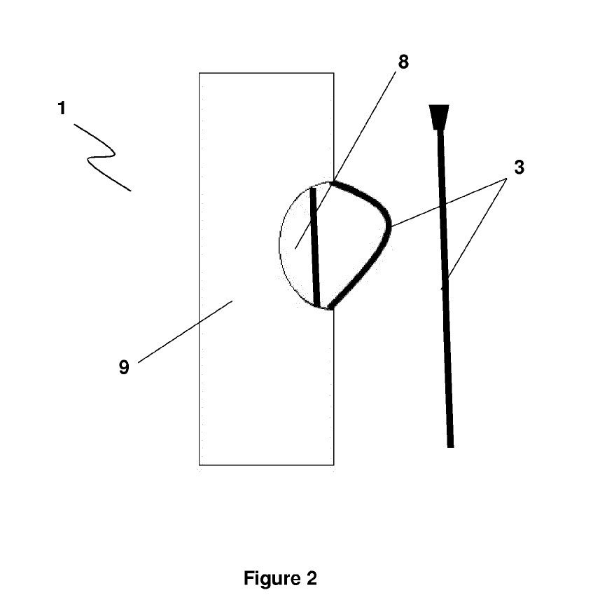

FIG. 2 is a perspective view of the side of the container for flexible elongate members.

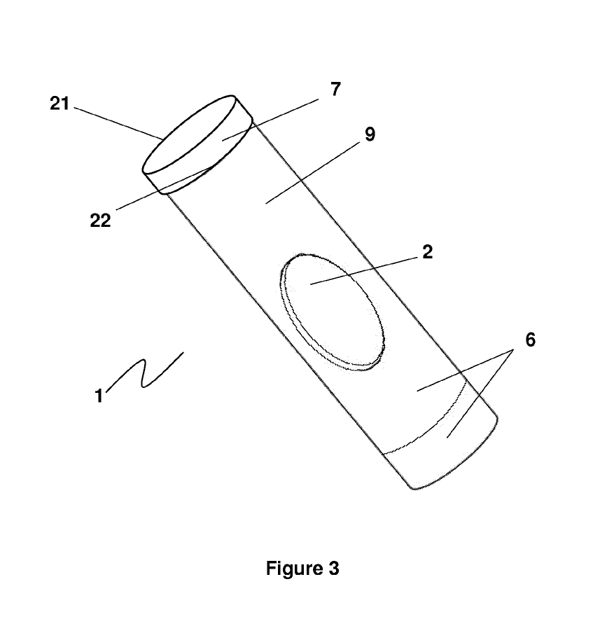

FIG. 3 is a perspective view of the container comprising modular tubular bodies.

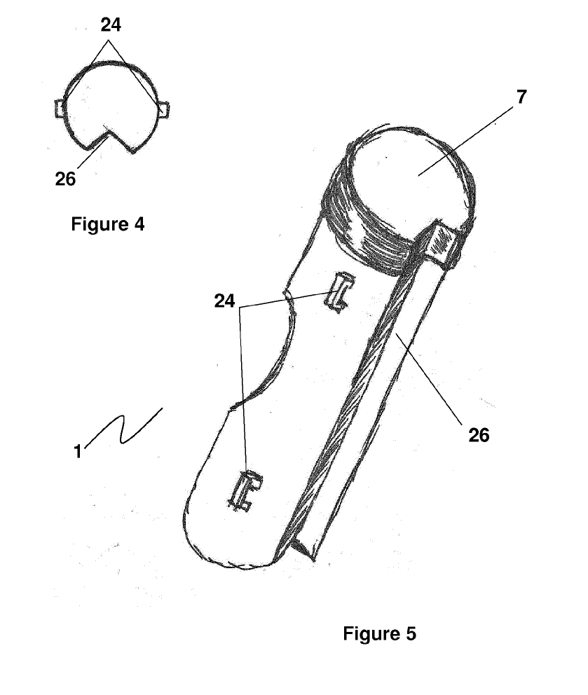

FIG. 4 is a cross-sectional view of the container comprising the auxiliary locating and securing means.

FIG. 5 is a perspective view of the container comprising the auxiliary locating and securing means.

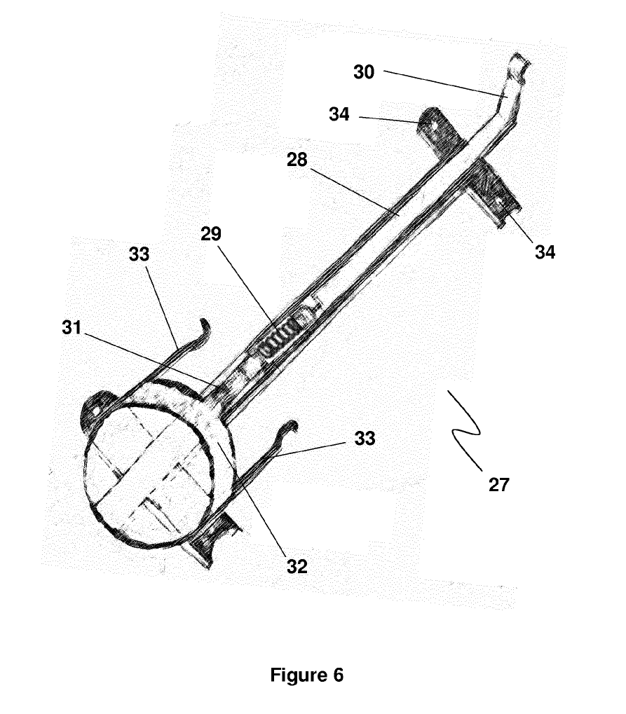

FIG. 6 is a perspective view of the holder of securing the container for flexible elongate members.

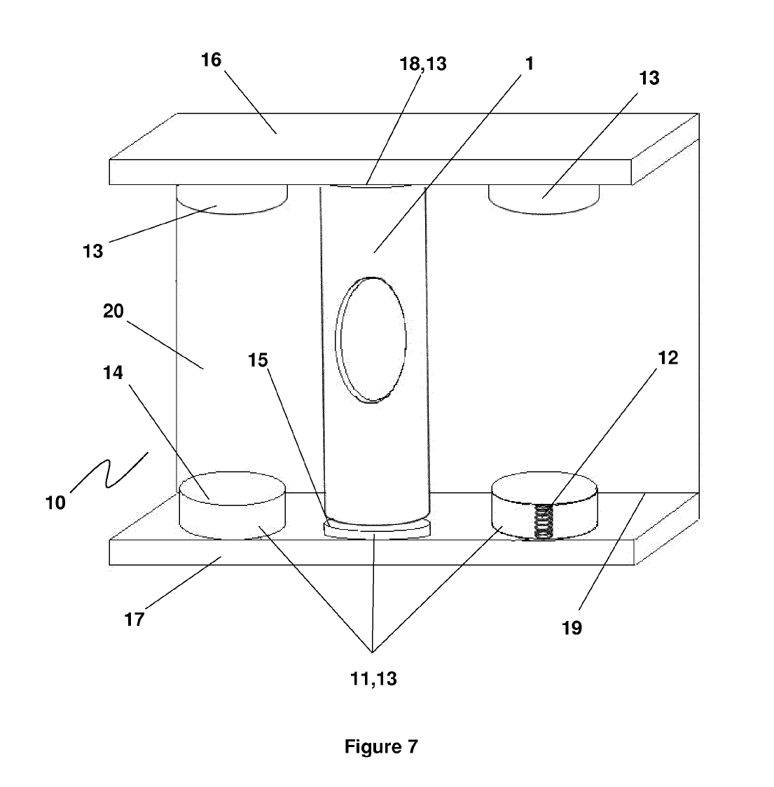

FIG. 7 is a perspective view of the rack for securing the container(s) for flexible elongate members.

In the drawings, there is shown a container indicated generally by the reference numeral 1 for the storage and transport of flexible elongate members namely cable-ties. The container 1 having an aperture 2 for removal of the flexible elongate members 3. The portion of the container 1 defining the aperture 2 having means for maintaining at least part of a perimeter 4 of the aperture 2 in a non-planar orientation.

The non-planar orientation of at least part of the perimeter 4 of the aperture 2 means that an operator can always place their thumb and index finger in alignment or partially aligned to the flexible elongate member 3 so that upon closing their thumb and index finger they will be able to apply a clamping force onto at least part of opposing sides of the body of an flexible elongate member 3 proximal to the aperture 2.

The non-planar orientation of all or part of the perimeter 4 creates a three dimensional space around the flexible elongate members 3. The portion of the container 1 defining the aperture 2 is able to maintain at least part of the perimeter 4 of the aperture 2 in a convex or concave orientation. FIG. 2 illustrates the aperture 2 in the concave orientation. It is this concave or convex orientation of the perimeter 4 which creates a three dimensional space around the cable-ties 3.

The aperture 2 is located towards or about the middle of the container relative to at least two opposite ends 5. The aperture 2 has also been adapted to receive a thumb and an index finger of the operator in an open position and in a closed grasping position and to prevent the flexible elongate members 3 coming out of the container 1 without operator intervention; as shown in FIG. 2.

The container 1 is an elongate container whereby either the container 1 is rigid or at least all or part of the portion of the container 1 defining the aperture 2 is rigid. The container 1 maintains a tubular body of a cylindrical shape. Alternatively, the container has a polygonal shaped cross-section such as but not limited to a rectangular or pentagonal or hexagonal or heptagonal or octagonal cross-section. The container 1 is comprised of a single moulded unit, pre-moulded to shape using injection moulding.

Alternatively as shown in FIG. 3, the container 1 comprises modular tubular bodies 6. This allows different lengths of containers 1 to be formed by adding tubular bodies 6 to an existing container 1 to accommodate various lengths of flexible elongate members 3. The tubular body 6 has at least one openable end with a lid 7 for receiving the flexible elongate members 3. The openable end being an optional feature to the present invention.

The lid 7 can be separable or rotatable couplable to the tubular body of the container 1. The lid 7 comprising a closed end 21 and an open end 22 for positively engaging the open end of the tubular body of the container 1. A portion internal profile of the lid 7 may be provided with an interference means for positively engaging the open end of the tubular body of the container 1. This enables the lid 7 to be easily pressed onto and pulled off the container 1. Alternatively, a portion of the inner profile of the lid 7 and a corresponding portion of the external profile of the tubular body of the container 1 comprise threading means (now shown). The threading means would provide the lid 7 with a screw-like function to rotate onto and off from the tubular body of the container 1. Further alternatively, the lid 7 is mechanically coupled to the tubular body of the container 1 by a hinge (not shown). The hinge (not shown) located proximal to the at least one openable end of the container 1. The hinge further comprises a latch (not shown), to fasten the lid in position upon the tubular body of the container 1. Advantageously, a container 1 for flexible elongate members 3 which comprises at least one end that is openable, provides a user with an ease of access to the container 1 to quickly and easily refill the receptacle with cable-ties 3.

The container 1 is mountable upon a wall, structural frames, tool boxes, workbenches, vans or the like. Alternatively, the container 1 is mountable upon a portion of the operator himself such as but not limited to the operator's leg.

The container 1 comprises a fixed mounting component and/or a removably detachable mounting component to mount the container 1. By fixed and removable mounting components we mean that the fixed mounting component is permanently fixed to the tubular body of the container 1 whereas a removably detachable mounting component (not shown) can be disengaged from the container 1 when required.

The mounting component is located at the upper half of the tubular body proximal to the aperture and such that when the container 1 is in use or mounted the flexible elongate members 3 can be removed from the container 1 through the aperture 2. The mounting component 23 is a clamp or hook or fixing lug or similar mechanical fixings; as shown in FIG. 1 in the form of a fixing lug.

The container 1 comprises at least one pair of correspondingly located protrusions 24 protruding a short distance from the external surface of the tubular body of the container 1. Most ideally the container 1 comprises two pairs of correspondingly located protrusions 24. One pair of protrusions 24 located within the lower half of the tubular body proximal to the lower end of the container 1, the other pair located in the upper half of the tubular body proximal to the upper end of the container 1. The protrusions 24 protruding a short distance are located in a position whereby when the container 1 is in use or mounted the flexible elongate members 3 can be removed from the container through the aperture 2.

The protrusions 24 comprise apertures 25 to enable removably detachable mounting components such as a flexible elongate member 3, an elastic member, Velcro® strip, cord or the like to pass through the protrusions 24 to enable mounting of the container 1.

The apertures 25 are geometrically designed to enable both screws or the like and/or a removably detachable mounting components such as an flexible elongate member 3 to mount the container 1 depending on the requirements of the user. The hybrid aperture 25 is geometrically designed with a cross like/cruciform configuration to enable both types of mounting means; as shown in Detail A of FIG. 1, Detail A can also be applied to the apertures of FIG. 6.

As shown in FIGS. 4 and 5 the container 1 has an auxiliary locating and securing member 26 created by a portion of the tubular body wall protruding a short distance into the tubular body. The auxiliary locating and securing member 26 is located in a position whereby when the container 1 is in use or mounted the flexible elongate members 3 can be removed from the container 1 through the aperture 2 and extends the entire longitudinal length of the tubular body of the container 1. The auxiliary locating and securing member 26 is wedge shaped angled at or about 90°.

Advantageously, the auxiliary locating and securing member 26 enables an operator to further securely mount the tubular body to the corners of any work-bench, vehicle, wall or the like. The 90° or similar angle of the securing feature enables the corner of the external structure to nest with the inherent tubular structure of the container 1.

The aperture 2 extends longitudinally along a part of the length of the container 1 and extends circumferentially around at least part of the tubular body of the container 1. The aperture 2 being adapted to extend in the range of 10% to 50% of the longitudinal length and circumference of the container 1. Advantageously, the perimeter 4 of the aperture 2 extending circumferentially around at least part of the tubular body of the container 1 creates a three dimensional non-planar cavity cutting a jaw shaped cavity 8 through the tubular wall 9 of the container 1 (see especially FIG. 3). This three dimensional non-planar opening through the tubular wall 9 provides the space for an operator to place their thumb and finger or two fingers or some mechanical gripping means manually or electronically operated on opposing sides of and in alignment with the cable-tie 3.

A range of longitudinal lengths and widths of the container 1 are provided to accommodate various lengths and widths of flexible elongate members 3. The container 1 is formed of a plastic composite, a metallic material or a substrate comprising a bibulous matrix such as cardboard or any other suitable material.

In FIG. 6 of the drawings there is shown a first embodiment of a holder generally reference by numeral 27 for a container for the storage of flexible elongate members 1 comprising a holder 27 being length adjustable between a container inserting extended position and a container mounted retracted position, the holder having a spring 29 normally biasing the holder into the container 1 mounted retracted position.

The holder 27 for a container for the storage of flexible elongate members 1 comprises a two part structural frame 28 and a biasing component 29 for operable engagement with the two part structural frame to secure the container 1 to the structural frame of the holder 28.

The structural frame of the holder 28 comprises two rigid frame members—an upper frame member 30 and a lower frame member 31. The two rigid frame members (30 and 31) operably coupled by the biasing component 29. The frame members (30 and 31) are displaceable relative to the other under control of the spring 29 as a result of the application of force by the operator.

The spring 29 is designed for applying a compressive force onto the container 1 for the engagement of the container within the holder 27. The rigid frame members (30 and 31) are capable of withstanding the compressive forces applied by the spring 29.

The lower frame member 31 and/or upper frame member 30 comprises a base member 32 for supporting the container 1 within the holder 27 by the use of one or more deformable stabilising components 33 for positively engaging the outer profile of the container 1. The base member 32 protrudes orthogonally relative to the frame members (30 and 31).

The holder is mountable upon a wall, tool box, workbench, van or the like by the use of mounting components 34 connected to one or both frame members as shown in both FIG. 7 and Detail A of FIG. 1.

The holder 27 is formed of a plastic composite, a metallic material or any other suitable material.

In FIG. 7 of the drawings there is shown a rack indicated generally by the reference numeral 10 for a plurality of containers 1 for the storage of flexible elongate members 3 namely cable-ties. The rack 10 comprising three releasable engaging components 11 for releasably securing a plurality of containers 1 to the rack 10 (one container 1 being shown). The container 1 as described above has an aperture 2 for at least removal of the cable-ties 3. At least the portion of the container 1 defining the aperture 2 maintains at least part of the perimeter 4 of the aperture 2 in a non-planar orientation.

The rack 10 comprises three releasable engaging components 11 to connect a plurality of containers 1 for the storage of cable-ties 3. The releasable engaging components 11 comprises biasing member 12 for applying a compressive force onto the container 1 to securely maintain the container 1 in connection to the rack 10.

The releasable engaging components 11 comprise a pair of spaced apart holders 13 for engaging both ends of the container 1. The pairs of holders 13 being spaced apart on the rack 10 by different distances to enable an operator to utilise a variety of containers 1 to accommodate different thickness and lengths of cable-ties 3.

The holders 13 have a spring 12 connected to the rack 10. The spring 12 allows the holder 13 to move towards and away from the rack 10 allowing an operator to insert the container 1.

The releasable engaging component 11 is a quick release connecting component. The releasable engaging component 11 comprises at least one holder 13 to engage with the container 1. Advantageously, a releasable engaging component 11 comprising at least one holder 13 and a spring 12 enables an operator with a quick and simple method of container 1 exchange should varying lengths and thicknesses of containers 1 be required.

The releasable engaging component 11 having an extended position 14 and a retracted position 15. The normal orientation of the releasable engaging component 11 is in its extended position 14; as illustrated in FIG. 4. The application of force by an operator pressing the container 1 onto the releasable engaging component compresses the spring 12 towards a portion of the rack 10.

The spring 12 of the rack biases the holder 13 back into the extended position 14. The tensile forces of the spring 12 placed upon the container 1 clamps the container 1 in position on the rack 10. This clamp like mechanism maintains a secure connection between the container 1 and the rack 10.

The rack 10 comprises an upper 16 and lower 17 rack member. At least one of the upper 16 or lower 17 rack member has a releasable engaging component 11. Where the lower rack member 17 houses the releasable engaging component 11 the container 1 is forced towards an abutment portion of the rack 18 located upon the upper rack member 16. The opposite is true should the housing location of the releasable engaging component 11 be reversed.

The upper 16 and lower 17 rack members are connectable along at least one lateral edge 19 by a connecting spine 20 and protrude orthogonally from the connecting spine 20. The rack members (16 and 17) are rigid rack members capable of withstanding the compressive and tensile forces applied by the releasable engaging component 11.

The rack 10 is mountable upon a wall, tool box, workbench, van or the like (not shown) by a mounting element (not shown) such as a clamp or hook or similar mechanical fixings.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof.

1. A container for flexible elongate members, comprising:
an aperture for at least removal of the flexible elongate members, wherein at least a portion of the container defining the aperture having means for maintaining at least part of a perimeter of the aperture in a non-planar orientation.

2. The container for flexible elongate members as claimed in claim 1, wherein the non-planar orientation of all or part of the perimeter creates a three dimensional space around the flexible elongate members.

3. The container for flexible elongate members as claimed in claim 2, wherein the portion of the container defining the aperture having means for maintaining at least part of the perimeter of the aperture in a convex or concave orientation.

4. The container for flexible elongate members as claimed in claim 3, wherein the portion of the container defining the aperture having means for maintaining at least one part of the perimeter of the aperture at an inclined angle relative to at least one other adjacent part of the perimeter of the aperture.

5. The container for flexible elongate members as claimed in claim 4, wherein the aperture being adapted to prevent the flexible elongate members coming out of the container without operator intervention.

6. The container for flexible elongate members as claimed in claim 5, wherein the aperture being adapted to receive a thumb and an index finger in an open position and in a closed grasping position.

7. The container for flexible elongate members as claimed in claim 6, wherein the aperture being adapted to allow a person to insert their thumb and index finger in an open position into the body of the container.

8. The container for flexible elongate members as claimed in claim 7, wherein all or part of the perimeter of the aperture is rigid and/or all or part of the portion of the container defining the aperture is rigid.

9. The container for flexible elongate members as claimed in claim 8, wherein the container is an elongate container.

10. The container for flexible elongate members as claimed in claim 9, wherein the aperture is located away from the ends of the container.

11. The container for flexible elongate members as claimed in claim 10, wherein the aperture is located towards or about the middle of the container relative to at least two opposite ends.

12. The container for flexible elongate members as claimed in claim 11, wherein the container has a tubular body.

13. The container for flexible elongate members as claimed in claim 12, wherein the container is comprised of a single moulded unit.

14. The container for flexible elongate members as claimed in claim 13, wherein the container is pre-moulded to shape using injection moulding.

15. The container for flexible elongate members as claimed in claim 14, wherein the container comprises modular tubular bodies.

16. The container for flexible elongate members as claimed in claim 12, wherein the tubular body has at least one openable end for receiving the flexible elongate members.

17. The container for flexible elongate members as claimed in claim 16, wherein the at least one openable end for receiving the flexible elongate members comprises a separable or rotatably coupleable detachable member, the detachable member being detachable from or moveable relative to the tubular body of the container.

18. The container for flexible elongate members as claimed in claim 17, wherein the detachable member comprises a closed end and an open end for positively engaging the open end of the tubular body of the container.

19. The container for flexible elongate members as claimed in claim 18, wherein the detachable member is deformable.

20. The container for flexible elongate members as claimed in claim 19, wherein an internal profile of the detachable member having an interference means extending along a portion of the detachable member for positively engaging the open end of the tubular body of the container.

21-42. (canceled)
